(19) United States
(12) Patent Application Publication
(10) Pub. No.: US 2025/0119876 A1
(43) Pub. Date: Apr. 10, 2025

(54) METHOD AND APPARATUS FOR LATENCY HANDLING OF SIDELINK REFERENCE SIGNAL TRANSMISSION IN A WIRELESS COMMUNICATION SYSTEM

(71) Applicant: ASUS Technology Licensing Inc., Taipei City (TW)

(72) Inventor: Ming-Che Li, Taipei City (TW)

(21) Appl. No.: 18/896,354

(22) Filed: Sep. 25, 2024

Related U.S. Application Data
(60) Provisional application No. 63/542,988, filed on Oct. 6, 2023.

(51) Int. Cl. H04W 72/02; H04L 5/00; H04W 72/40

(52) U.S. Cl. CPC H04W 72/02; H04L 5/0051; H04W 72/40

(57) ABSTRACT

Methods, systems, and apparatuses are provided for latency handling of sidelink reference signal transmission in a wireless communication system, wherein a method comprises receiving or having a configuration of a first sidelink resource pool for sidelink data transmission and sidelink reference signal transmission, performing a first sensing-based resource selection, triggered or requested in a first timing, for selecting one or more first sidelink resources in the first sidelink resource pool, determining a first set of candidate resources within a first time interval, determining a first subset of candidate resources after excluding some candidate resources from the first set of candidate resources based on one or more sensing results, selecting the one or more first sidelink resources from the first subset of candidate resources according to at least a second remaining packet delay budget and a remaining delay budget associated with a first sidelink reference signal, and performing a first sidelink data transmission and transmission of the first sidelink reference signal on a first sidelink resource of the selected one or more first sidelink resources.

### CROSS-REFERENCE TO RELATED APPLICATIONS

The present Application claims priority to and the benefit of U.S. Provisional Patent Application Ser. No. 63/542,988, filed Oct. 6, 2023, which is fully incorporated herein by reference.

### FIELD

This disclosure generally relates to wireless communication networks and, more particularly, to a method and apparatus for latency handling of sidelink reference signal transmission in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for latency handling of sidelink reference signal transmission in a wireless communication system. As such, when a device or User Equipment (UE) performs sensing-based resource selection in a shared resource pool, the latency requirement of Sidelink (SL) Positioning Reference Signals (PRSs) can be satisfied.

In various embodiments, a method for a first device in a wireless communication system comprises receiving or having a configuration of a first sidelink resource pool for sidelink data transmission and sidelink reference signal transmission, performing a first sensing-based resource selection, triggered or requested in a first timing, for selecting one or more first sidelink resources in the first sidelink resource pool, determining a first set of candidate resources within a first time interval, wherein the first time interval is determined based on at least a first remaining packet delay budget, determining a first subset of candidate resources after excluding some candidate resources from the first set of candidate resources based on one or more sensing results, selecting the one or more first sidelink resources from the first subset of candidate resources according to at least a second remaining packet delay budget and a remaining delay budget associated with a first sidelink reference signal, and performing a first sidelink data transmission and transmission of the first sidelink reference signal on a first sidelink resource of the selected one or more first sidelink resources.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a flow diagram of a method of a first device comprising receiving/having configuration of a sidelink resource pool for PSSCH transmission/reception and SL PRS transmission/reception, performing a first sensing-based resource selection, triggered/requested in a first slot n, for selecting one or more sidelink resources in the sidelink resource pool, determining a (initialized) set of candidate single-slot resources comprising multiple candidate single-slot resources within time interval [n+T₁, n+T₂], determining a subset of sidelink resources after excluding some candidate single-slot resources from the (initialized) set of candidate single-slot resources based on sensing results, selecting the one or more sidelink resources from the subset of sidelink resources, performing a first PSSCH transmission carrying a first SL MAC PDU, and performing the first SL PRS transmission on a first sidelink resource of the selected one or more sidelink resources, in accordance with embodiments of the present invention.

FIG. 6 is a flow diagram of a method of a first device comprising receiving or having a configuration of a first sidelink resource pool for sidelink data transmission and sidelink reference signal transmission, performing a first sensing-based resource selection, triggered or requested in a first timing, for selecting one or more first sidelink resources in the first sidelink resource pool, determining a first set of candidate resources within a first time interval, determining a first subset of candidate resources after excluding some candidate resources from the first set of candidate resources based on one or more sensing results, selecting the one or more first sidelink resources from the first subset of candidate resources according to at least a second remaining packet delay budget and a remaining delay budget associated with a first sidelink reference signal, and performing a first sidelink data transmission and transmission of the first sidelink reference signal on a first sidelink resource of the selected one or more first sidelink resources, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.213 V18.0.0 (2023-09) 3GPP; TSG RAN; NR; Physical layer procedures for control (Release 18); [2] 3GPP TS 38.214 V18.0.0 (2023 September) 3GPP; TSG RAN; NR; Physical layer procedures for data (Release 18); [3] 3GPP TS 38.214 V17.6.0 (2023 September) 3GPP; TSG RAN; NR; Physical layer procedures for data (Release 17); [4] RP-231460, “New WID on Expanded and Improved NR Positioning”, Intel; [5] RAN1 Chair's Notes of 3GPP TSG RAN WG1 #112bis; [6] RAN1 Chair's Notes of 3GPP TSG RAN WG1 #113; and [7] RAN1 Chair's Notes of 3GPP TSG RAN WG1 #114. The standards and documents listed above are hereby expressly and fully incorporated herein by reference in their entirety.

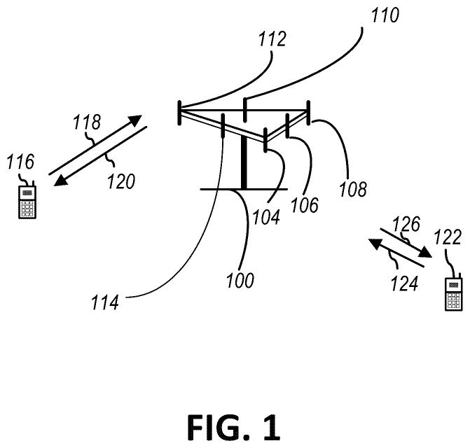

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

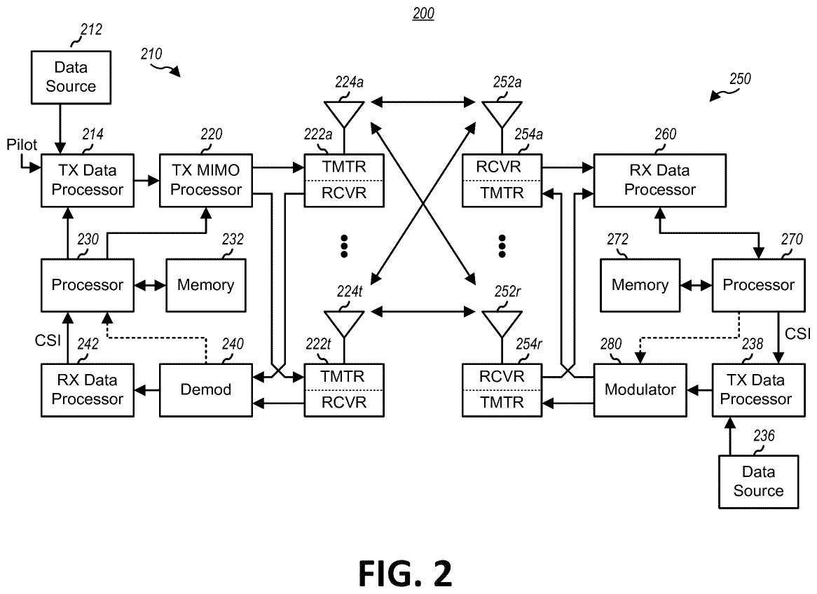

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

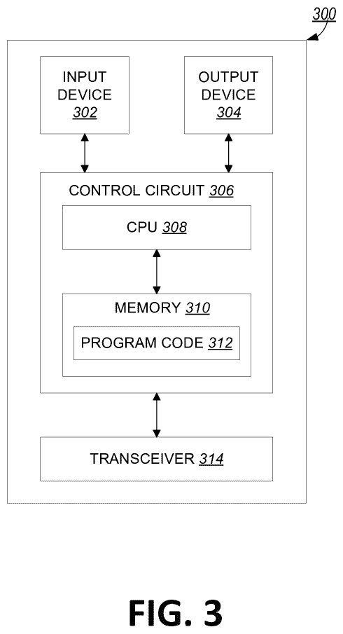

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

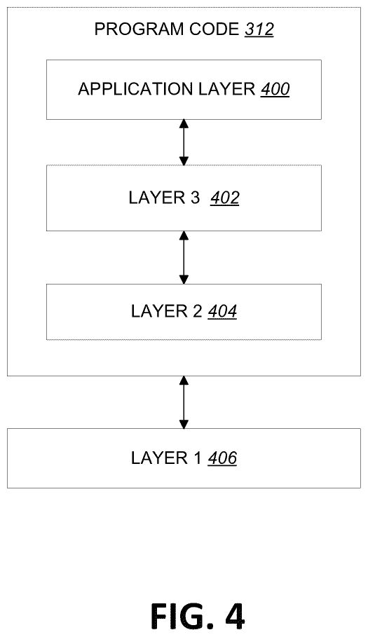

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

For New Radio (NR) Release-16/17 sidelink design, sidelink slots can be utilized for Physical Sidelink Broadcast Channel (PSBCH) or Physical Sidelink Control Channel (PSCCH)/Physical Sidelink Shared Channel (PSSCH)/Physical Sidelink Feedback Channel (PSFCH) transmission/reception. PSBCH is Time Division Multiplexed (TDMed), in slot level, from PSCCH/PSSCH/PSFCH. It means that sidelink slots except slots for PSBCH can be utilized for PSCCH/PSSCH/PSFCH transmission/reception. Moreover, the concept of a sidelink resource pool for sidelink communication is utilized for PSCCH/PSSCH and/or/PSFCH transmission/reception. A sidelink (communication) resource pool will comprise a set of sidelink slots (except at least slots for PSBCH) and a set of frequency resources. Different sidelink (communication) resource pools may be TDMed and/or Frequency Division Multiplexed (FDMed). More specifically, a PSCCH in one sidelink (communication) resource pool can only schedule PSSCH resource(s) in the same one sidelink (communication) resource pool. A PSCCH in one sidelink (communication) resource pool is not able to schedule PSSCH resource(s) in other sidelink (communication) resource pool. For a PSCCH/PSSCH, an associated PSFCH is in the same sidelink (communication) resource pool, instead of in different sidelink (communication) resource pools.

One sidelink (communication) resource pool will comprise multiple sub-channels in frequency domain, wherein a sub-channel comprises multiple contiguous Physical Resource Blocks (PRBs) in frequency domain. One PRB comprises multiple Resource Elements (REs), e.g., one PRB consists of 12 REs. Configuration of the sidelink resource pool will indicate the number of PRBs of each sub-channel in the corresponding sidelink resource pool. Sub-channel based resource allocation in frequency domain is supported for PSSCH. For a PSSCH resource scheduled by a PSCCH in the same sidelink slot, fixed relationship between the PSCCH and the PSSCH resource is specified, which means that the PSCCH will be located in the lowest (index of) sub-channel of the scheduled PSSCH resource. As for a scheduled PSSCH resource in different slot(s), a starting frequency position of the scheduled PSSCH resource will be scheduled/indicated by sidelink control information, instead of a fixed relationship.

In current NR Release-16/17 sidelink design, one Sidelink Control Information (SCI) could indicate at most three PSSCH resources via Frequency resource assignment and/or Time resource assignment in the SCI. The SCI may comprise a 1st stage SCI and a 2nd stage SCI. The 1st stage SCI may be transmitted via PSCCH.

The 2nd stage SCI may be transmitted via multiplexing with the scheduled PSSCH resource in the same sidelink slot, e.g., the first PSSCH resource. In other words, the SCI can schedule at most two PSSCH resources in later sidelink slots, e.g., the second PSSCH resource and/or the third PSSCH resource. The at most three PSSCH resources are in different slots in a sidelink (communication) resource pool. The at most three PSSCH resources are within 32 consecutive slots in a sidelink resource pool. The at most three PSSCH resources are utilized/associated with a same data packet, e.g., a same Transport Block (TB) or a same Medium Access Control (MAC) Protocol Data Unit (PDU). Note that standalone PSCCH/SCI is not supported in NR sidelink, which means that for each PSSCH transmission in a slot, there will be a corresponding PSCCH/SCI transmission in the same slot, and vice versa.

Moreover, resource reservation for another/different TB by a SCI could be (pre-) configured with, enabled, or not enabled, or not configured in a sidelink (communication) resource pool. When a sidelink (communication) resource pool is configured with an enabled such resource reservation, the sidelink (communication) resource pool is configured with a set of reservation period values. A possible reservation period could be 0, 1:99, 100, 200, 300, 400, 500, 600, 700, 800, 900, 1000 ms. A resource reservation period field in an SCI in the sidelink (communication) resource pool could indicate which reservation period value for (future) resource reservation. The size/number of the set of reservation period values could be from 1 to 16.

In current NR Release-16/17 sidelink design, there are two sidelink resource allocation modes defined for NR sidelink communication:
1. Mode 1 is that a base station/network node can schedule sidelink resource(s) to be used by a User Equipment (UE) for sidelink transmission(s); or
2. Mode 2 is that a UE determines (i.e., base station/network node does not schedule) sidelink transmission resource(s) within sidelink resources configured by a base station/network node or pre-configured sidelink resources.

For network scheduling mode, e.g., NR sidelink resource allocation mode 1, the network node may transmit a Sidelink (SL) grant, e.g., Downlink Control Information (DCI) format 3_0, on Uu interface for scheduling at most three PSSCH resources (for a same data packet). The sidelink grant also comprises “resource pool index” for indicating one sidelink (communication) resource pool, wherein the scheduled at most three PSSCH resources are within the indicated one sidelink (communication) resource pool. The Transmission (TX) UE may perform PSCCH and PSSCH transmissions on PC5 interface, in response to the received SL grant, for a data packet. The Uu interface means the wireless interface for communication between a network and a UE. The PC5 interface means the wireless interface for communication (directly) between UEs/devices.

For UE (autonomous) selection mode, e.g., NR sidelink resource allocation mode 2, since a transmission resource is not scheduled via the network node, the UE may require performing sensing before selecting a resource for transmission (e.g., sensing-based transmission), in order to avoid resource collision and interference from or to other UEs (especially UEs using NR sidelink). Full sensing is supported from NR Rel-16 sidelink, while partial sensing is supported from NR Rel-17 sidelink. Based on result of the sensing procedure, the UE can determine a valid/identified resource set. The valid/identified resource set may be reported to higher layers (of the UE). The UE may (randomly) select one or multiple valid/identified resources from the valid/identified resource set to perform sidelink transmission(s) from the UE. The sidelink transmission(s) from the UE may be PSCCH and/or PSSCH transmission.

When sensing-based resource selection is triggered/requested in slot n, (the Physical layer of) the UE will have a (initial) set of candidate single-slot resources comprising multiple candidate single-slot resources. The available (initial) set of candidate single-slot resources is restricted with a time interval [n+T₁, n+T₂], which may be called a resource selection window. Preferably in certain embodiments, one candidate single-slot resource may comprise one or multiple frequency resource units within one slot, wherein the frequency resource unit may be a sub-channel. As specified in TS 38.214 (e.g., [2] 3GPP TS 38.214 V18.0.0 (2023-09) 3GPP), a candidate single-slot resource for transmission R_{x,y} is defined as a set of L_{subCH} contiguous sub-channels with sub-channel x+j in slot t′_{y}^{SL} where j=0, . . . , L_{subCH}−1.

If full sensing is performed (e.g., [2] 3GPP TS 38.214 V18.0.0 (2023 September) 3GPP), e.g., partially sensing is not configured, the (initial) set of candidate single-slot resources are in the (full) time interval [n+T₁, n+T₂]. The (Physical layer of the) UE shall monitor/sense slots within sensing window [n−T₀, n−T_{proc,0}^{SL}).

When partial sensing is performed/configured (e.g., [2] 3GPP TS 38.214 V18.0.0 (2023 September) 3GPP), (the Physical layer of) the UE determines by its implementation a set of candidate slots which consists of at least Y candidate slots within the time interval [n+T₁, n+T₂], wherein the (initial) set of candidate single-slot resources are in the set of slots. For periodic-based partial sensing, if a slot t′_{y}^{SL} is in the set of candidate slots, (the Physical layer of) the UE shall monitor/sense any slot t′_{y-k×P}_{ᵣₑₛₑᵣᵥₑ}_{′}^{SL} within the sensing window. For contiguous partial sensing, (the Physical layer of) the UE shall monitor/sense slots [n+T_{A}, n+T_{B}] within the sensing window, wherein T_{A} and T_{B} are both selected such that (the Physical layer of) the UE has sensing results starting at least M consecutive logical slots before the first slot of the selected Y candidate slots.

Based on the sensing result, (the Physical layer of) the UE may generate a valid/identified resource set, wherein the valid/identified resource set is a subset of the (initial) set of candidate single-slot resources. The generation of the valid/identified resource set may be performed via excluding some candidate single-slot resources from the (initial) set of candidate single-slot resources. If remaining candidate single-slot resources after exclusion steps is smaller than X (e.g., either of 20%, 35%, 50% depending on prio_{TX}, which association is configured in sidelink resource pool configuration) of the number of the (initial) set of candidate single-slot resources, the UE may re-perform the exclusion step via increasing the power threshold by 3 dB. After then, (the Physical layer of) the UE can determine the valid/identified resource set. The resource selection for sidelink transmission, performed by the higher layer (MAC layer) of the UE, may be randomly selected from the valid/identified resource set.

Note that for sidelink, a priority value is any of 1 to 8, and a lower priority value means higher priority.

In NR Release 18 (e.g., [4] RP-231460), “NR Positioning Enhancements” will investigate higher accuracy, lower latency location, high integrity and reliability requirements resulting from new applications and industry verticals for 5G. It will also study feasibility of potential solutions for SL positioning, considering relative positioning, ranging and absolute positioning, wherein the SL positioning is operated in a device-to-device interface or said PC5-interface between a device and a device. The device can mean or replaced as a UE.

RAN1 agreed to study Round-Trip Time (RTT)-type solutions using SL, SL-Angle of Arrival (AoA), SL-Time Difference Of Arrival (TDOA), SL-Angle of Departure (AoD) with regard to positioning methods supported using SL measurements. Accordingly, a new reference signal for SL positioning/ranging, noted as SL Positioning Reference Signal (PRS), will be introduced. For supporting time-based positioning methods, larger bandwidth for SL PRS is required for higher accuracy positioning. It is quite possible that the required bandwidth for SL PRS may be 10 MHz, 20 MHz, or even more, especially in higher frequency bands. With regard to the SL Positioning resource allocation, there are two kinds of sidelink resource pools: Dedicated resource pools for SL-PRS and Shared resource pools with sidelink communication (i.e., PSCCH/PSSCH and/or PSFCH). Shared resource pools with sidelink communication means that SL PRS transmission(s) can be multiplexed with PSCCH/PSSCH/PSFCH resources in the shared resource pool.

Moreover, sidelink control information by a TX UE may schedule/indicate/allocate SL PRS resources, in order to let a Reception (RX) UE know where/when to receive/measure a corresponding SL PRS. The sidelink control information for scheduling/indicating/allocating SL PRS resources may be transmitted on PSCCH in the dedicated resource pool for SL-PRS, or be transmitted on PSCCH and/or 2-nd stage SCI in the shared resource pool.

Furthermore, given the larger bandwidth requirement of SL PRS, Comb-N SL-PRS design can be supported for providing more available SL PRS resources, and a configured/adjusted symbol number can be supported as one SL PRS occasion. The potential candidate value of N may be 1, 2, 4, 6, and there are at least some possible designs of SL PRS patterns, given M symbol and comb-N:
1. Fully staggered SL-PRS pattern, M=N, and at each symbol a different RE offset is used, or
2. Partially staggered SL-PRS pattern, M<N, at each symbol a different RE offset is used, or
3. Unstaggered SL-PRS patterns, N>1, at each symbol a same RE offset is used

Preferably in certain embodiments, for comb-N SL-PRS design/structure, possible frequency/comb offsets may be 0 to (N−1).

For SL PRS resource allocation, scheme 1 and scheme 2 are introduced.
1. Scheme 1: Network-centric operation SL-PRS resource allocation (e.g., similar to a legacy NR Mode 1 solution),
   a. The network (e.g., Next Generation Node B (gNB), Location Management Function (LMF), gNB & LMF) allocates resources for SL-PRS.
2. Scheme 2: TX UE autonomous SL-PRS resource allocation (e.g., similar to legacy NR Mode 2 solution),
   a. At least one of the UE(s) participating in the sidelink positioning operation allocates resources for SL-PRS.

For scheme 1, the network node may transmit an SL grant, e.g., DCI format 3_2, for scheduling SL PRS resource(s) in the dedicated resource pool. The network node may transmit an SL grant, e.g., DCI format 3_0, for scheduling PSSCH resource(s) in the shared resource pool, and the TX UE determines whether to multiplex the SL PRS transmission in the scheduled PSSCH resource(s).

For dedicated resource pool in scheme 2, the TX UE may perform sensing on SL PRS resources in sensing duration, and then exclude candidate SL PRS resources based on the sensing result. After the exclusion step, the TX UE may determine valid candidate SL PRS resources and then randomly select some candidate SL PRS resource(s) from that. For shared resource pool in scheme 2, the TX UE may perform sensing, determine valid candidate PSSCH resources and then randomly select some candidate PSSCH resource(s) from that (following legacy NR Mode). The TX UE determines whether to multiplex SL PRS transmission in the selected PSSCH resource(s). For the Dedicated resource pool for SL-PRS, it is agreed to support TDM-based multiplexing of SL PRS within a slot, wherein the maximum number of TDMed SL PRS occasions within the slot is 4 (e.g., [6] RAN1 Chair's Notes of 3GPP TSG RAN WG1 #113).

As specified in TS 38.214 (e.g., [2] 3GPP TS 38.214 V18.0.0 (2023 September) 3GPP), when sensing-based resource selection for PSSCH resource(s) is triggered/requested in slot n, the UE will determine a (initialized) set of candidate single-slot resources comprising multiple candidate single-slot resources which are restricted with time interval [n+T₁, n+T₂] (i.e., resource selection window). The UE may exclude some candidate single-slot resources from the (initialized) set of candidate single-slot resources, based on sensing results. After exclusion, the UE can determine a valid/identified resource set to be reported to the higher layer of the UE. The higher layer of the UE may (randomly) select one or multiple valid/identified resources from the valid/identified resource set to perform PSSCH transmission(s) carrying SL MAC PDU. Considering a latency requirement, when sensing-based resource selection for PSSCH resource(s) is triggered/requested, the higher layer of the UE will provide a remaining Packet Delay Budget (PDB) of SL data available in the logical channel(s), wherein the remaining PDB is utilized to determine the ending time of the time interval [n+T₁, n+T₂]. The SL data available in the logical channel(s) may be transmitted via the PSSCH transmission(s) on the selected one or multiple valid/identified resources (i.e., the SL data available in the logical channel(s) may be comprised/included in the SL MAC PDU). If T_{2 min} is shorter than the remaining PDB (in slots) then T₂ is up to UE implementation subject to T_{2 min}≤T₂≤remaining PDB (in slots); otherwise T₂ is set to the remaining PDB (in slots). Moreover, when the UE (randomly) selects the one or multiple valid/identified resources from the valid/identified resource set, the UE will consider the remaining PDB and/or the latency requirement of the triggered SL-Channel State Information (CSI) reporting (e.g., when the SL MAC PDU comprises/includes the triggered SL-CSI reporting) and/or the latency requirement of the Sidelink Inter-UE Coordination Information transmission (e.g., when the SL MAC PDU comprises/includes the Sidelink Inter-UE Coordination Information).

Regarding SL PRS in scheme 2 in the dedicated resource pool, the UE may perform sensing-based resource selection for SL PRS resource(s), which is designed via using sensing-based resource selection for PSSCH resource(s) as a starting point and considering some modifications. As agreements in RAN1 #112bis (e.g., [5] RAN1 Chair's Notes of 3GPP TSG RAN WG1 #112bis), RAN1 #114 (e.g., [7] RAN1 Chair's Notes of 3GPP TSG RAN WG1 #114), and specified in TS 38.214 (e.g., [2] 3GPP TS 38.214 V18.0.0 (2023-09) 3GPP), one modification is to substitute the PDB with a new delay budget for SL PRS. It is because SL PRS does not belong to SL data in/from sidelink logical channel(s), there is no PDB for SL PRS. The new delay budget for SL PRS may mean/represent a latency requirement of the SL PRS transmission, thus the selected SL PRS resources(s) can ensure to satisfy latency requirements of the SL PRS transmission.

Regarding SL PRS in scheme 2 in the shared resource pool, since SL PRS transmission is multiplexed with PSSCH, the UE can perform sensing-based resource selection for PSSCH resource(s) and multiplex SL PRS transmission(s) with PSSCH transmission(s) on selected PSSCH resource(s). However, the new delay budget for SL PRS is not considered in the sensing-based resource selection for PSSCH resource(s) in the shared resource pool as specified in TS 38.214 (e.g., [2] 3GPP TS 38.214 V18.0.0 (2023 September) 3GPP), it is possible that the selected PSSCH resource(s) cannot satisfy latency requirements of the SL PRS transmission.

To deal with these issues, some concepts, mechanisms, methods, or embodiments are provided in the following disclosure.

A UE may receive/have configuration of a sidelink resource pool for PSSCH transmission/reception and SL PRS transmission/reception.

The UE may perform a first sensing-based resource selection, triggered/requested in a first slot n, for selecting one or more sidelink resources in the sidelink resource pool. The UE may determine a procedure for determining a subset of sidelink resources, and select the one or more sidelink resources from the subset of sidelink resources.

The UE may determine a (initialized) set of candidate single-slot resources comprising multiple candidate single-slot resources within time interval [n+T₁, n+T₂]. The time interval [n+T₁, n+T₂] may be called/noted as a resource selection window.

The UE may exclude some candidate single-slot resources from the (initialized) set of candidate single-slot resources, based on sensing results. After exclusion, the UE can determine the subset of sidelink resources to be reported to the higher layer of the UE. The higher layer of the UE may (randomly) select the one or more sidelink resources from the reported subset of sidelink resources.

The UE may perform a first PSSCH transmission carrying a first SL MAC PDU and perform a first SL PRS transmission on a first sidelink resource of the selected one or more sidelink resources. Preferably in certain embodiments, the first SL PRS transmission is multiplexed with the first PSSCH transmission on the first sidelink resource.

### Concept A

The concept A is that the UE may determine the time interval [n+T₁, n+T₂] based on a (remaining) packet delay budget and a (remaining) delay budget associated with the first SL PRS. Preferably in certain embodiments, the UE may determine the T₂ based on the (remaining) packet delay budget and the (remaining) delay budget associated with the first SL PRS.

Preferably in certain embodiments, the SL MAC PDU may comprise SL data in/from sidelink logical channel(s). The packet delay budget may be determined/associated with the SL data or the sidelink logical channel(s).

Preferably in certain embodiments, the delay budget associated with the first SL PRS may be provided by the higher layer, e.g., Sidelink Long Term Evolution (LTE) Positioning Protocol (SLPP) or application layer. Preferably in certain embodiments, the first SL PRS may not belong to SL data. Preferably in certain embodiments, the first SL PRS may not belong to sidelink logical channels for SL data. Preferably in certain embodiments, the SL MAC PDU does not comprise the first SL PRS.

In one embodiment A1, the UE may determine the T₂ and/or the resource selection window based on a smaller/shorter one of the (remaining) packet delay budget and the (remaining) delay budget associated with the first SL PRS.

Preferably in certain embodiments, when the (remaining) packet delay budget is smaller/shorter than (or equal to) the (remaining) delay budget associated with the first SL PRS, the UE may determine the T₂ and/or the resource selection window based on the (remaining) packet delay budget. Preferably in certain embodiments, when T_{2 min} is shorter than the remaining packet delay budget (in slots), the T₂ is up to UE implementation subject to T_{2 min}≤T₂≤the (remaining) packet delay budget (in slots). When the remaining packet delay budget (in slots) is shorter than the T_{2 min}, the T₂ is set to the (remaining) packet delay budget (in slots).

Preferably in certain embodiments, when the (remaining) delay budget associated with the first SL PRS is smaller/shorter than (or equal to) the (remaining) packet delay budget, the UE may determine the T₂ and/or the resource selection window based on the (remaining) delay budget associated with the first SL PRS. Preferably in certain embodiments, when T_{2 min} is shorter than the (remaining) delay budget associated with the first SL PRS (in slots), the T₂ is up to UE implementation subject to T_{2 min}≤T₂≤the (remaining) delay budget associated with the first SL PRS (in slots). When the (remaining) delay budget associated with the first SL PRS (in slots) is shorter than the T_{2 min}, the T₂ is set to the (remaining) delay budget associated with the first SL PRS (in slots).

In one embodiment A2, the UE may determine the T₂ and/or the resource selection window based on one, with smaller priority value, of the (remaining) packet delay budget and the (remaining) delay budget associated with the first SL PRS. Preferably in certain embodiments, the SL MAC PDU or the SL data may be associated with a first priority value. The first SL PRS may be associated with a second priority value.

Preferably in certain embodiments, when the first priority value is smaller than (or equal to) the second priority value, the UE may determine the T₂ and/or the resource selection window based on the (remaining) packet delay budget. Preferably in certain embodiments, when T_{2 min} is shorter than the remaining packet delay budget (in slots), the T₂ is up to UE implementation subject to T_{2 min}≤T₂≤the (remaining) packet delay budget (in slots). When the remaining packet delay budget (in slots) is shorter than the T_{2 min}, the T₂ is set to the (remaining) packet delay budget (in slots).

Preferably in certain embodiments, when the second priority value is smaller than (or equal to) the first priority value, the UE may determine the T₂ and/or the resource selection window based on the (remaining) delay budget associated with the first SL PRS. Preferably in certain embodiments, when T_{2 min} is shorter than the (remaining) delay budget associated with the first SL PRS (in slots), the T₂ is up to UE implementation subject to T_{2 min}≤T₂≤the (remaining) delay budget associated with the first SL PRS (in slots). When the (remaining) delay budget associated with the first SL PRS (in slots) is shorter than the T_{2 min}, the T₂ is set to the (remaining) delay budget associated with the first SL PRS (in slots).

For each embodiment, when the UE performs a second sensing-based resource selection for second PSSCH transmission without multiplexing SL PRS in the sidelink resource pool, the UE may determine corresponding T₂ and/or corresponding resource selection window based on (remaining) packet delay budget and not based on (remaining) delay budget associated with SL PRS.

### Concept B

The UE may determine the time interval [n+T₁, n+T₂] based on a (remaining) packet delay budget. The UE may or may not determine the time interval [n+T₁, n+T₂] based on a (remaining) delay budget associated with the first SL PRS. Preferably in certain embodiments, the UE may determine the T₂ based on the (remaining) packet delay budget. The UE may or may not determine the T₂ based on the (remaining) delay budget associated with the first SL PRS.

Preferably in certain embodiments, the SL MAC PDU may comprise SL data in/from sidelink logical channel(s). The packet delay budget may be determined/associated with the SL data or the sidelink logical channel(s).

Preferably in certain embodiments, the delay budget associated with the first SL PRS may be provided by higher layer, e.g., SLPP or application layer. Preferably in certain embodiments, the first SL PRS may not belong to SL data. Preferably in certain embodiments, the first SL PRS may not belong to sidelink logical channels for SL data. Preferably in certain embodiments, the SL MAC PDU does not comprise the first SL PRS. Preferably in certain embodiments, the delay budget associated with the first SL PRS may mean/represent/replace as latency requirement of the first SL PRS.

The concept B is that when the UE (randomly) selects the one or more sidelink resources from the reported subset of sidelink resources, the UE may select the one or more sidelink resources according to at least the (remaining) packet delay budget and the (remaining) delay budget associated with the first SL PRS. Preferably in certain embodiments, the UE may select the one or more sidelink resources such that the one or more sidelink resources are within at least the (remaining) packet delay budget and the (remaining) delay budget associated with the first SL PRS. Preferably in certain embodiments, the one or more sidelink resources are within the (remaining) packet delay budget. And the one or more sidelink resources are within the (remaining) delay budget associated with the first SL PRS.

Preferably in certain embodiments, when the UE performs a second sensing-based resource selection for second PSSCH transmission without multiplexing SL PRS in the sidelink resource pool, the UE may select the one or more sidelink resources according to at least the (remaining) packet delay budget. The UE may select the one or more sidelink resources not according to the (remaining) delay budget associated with the SL PRS.

One possible text proposal with underline for TS 38.321 can be:

Note that any of the above and herein methods, alternatives, concepts, examples, and embodiments may be combined, in whole or in part, or applied simultaneously or separately.

For the methods, alternatives, concepts, examples, and embodiments detailed above and herein, the following aspects and embodiments are possible.

Preferably in certain embodiments, the SL PRS may be SL Channel State Information Reference Signal (CSI-RS).

Preferably in certain embodiments, the SL PRS is not SL CSI-RS.

Preferably in certain embodiments, the SL PRS may be represented/replaced as a sidelink reference signal.

Preferably in certain embodiments, the sidelink reference signal may be applied/utilized for (absolute and/or relative) positioning and/or ranging.

Preferably in certain embodiments, the sidelink reference signal may be applied/utilized for any of time-based positioning/ranging methods and/or angle-based positioning/ranging methods. Preferably in certain embodiments, the sidelink reference signal may be applied/utilized for any of TDoA, RTT-based positioning/ranging, AoA, AoD, or carrier phase measurement based positioning

Preferably in certain embodiments, the sidelink reference signal may be SL beam management RS. Preferably in certain embodiments, the sidelink reference signal may be SL CSI-RS (for beam management), which is not combined within a PSSCH (bandwidth) in frequency domain. Preferably in certain embodiments, the sidelink reference signal may require large bandwidth. Preferably in certain embodiments, the sidelink reference signal may be utilized for (High-Resolution) localization, sensing, or imaging. Preferably in certain embodiments, the sidelink reference signal may be utilized for beam management (e.g., in Frequency Range (FR)2).

Preferably in certain embodiments, any of above and herein concepts, methods, examples, alternatives, and embodiments for SL PRS may be applied for other/another reference signal (e.g., reference signal designed/introduced in future 5G, 6G, or etc.).

Preferably in certain embodiments, any of above and herein concepts, methods, examples, alternatives, and embodiments for SL PRS may be applied for SL CSI-RS (for beam management).

Preferably in certain embodiments, any of above and herein concepts, methods, examples, alternatives, and embodiments for SL PRS may be applied for reference signal for (High-Resolution) localization (e.g., reference signal designed/introduced in future 5G, 6G, or etc.).

Preferably in certain embodiments, any of above and herein concepts, methods, examples, alternatives, and embodiments for SL PRS may be applied for reference signal for (High-Resolution) sensing (e.g., reference signal designed/introduced in future 5G, 6G, or etc.).

Preferably in certain embodiments, any of above and herein concepts, methods, examples, alternatives, and embodiments for SL PRS may be applied for reference signal for (High-resolution) imaging (e.g., reference signal designed/introduced in future 5G, 6G, or etc.).

Preferably in certain embodiments, the sidelink resource pool for PSSCH transmission/reception and SL PRS transmission/reception may be a sidelink (communication) resource pool for PSSCH transmission/reception and enabled/configured/supported for SL PRS transmission/reception/measurement.

Preferably in certain embodiments, the dedicated resource pool for SL PRS may be a sidelink resource pool comprising/providing at least SL PRS resources and/or sidelink control resources. Preferably in certain embodiments, the dedicated resource pool for the SL PRS does not comprise sidelink data resources (i.e., does not comprise PSSCH resources). Preferably in certain embodiments, the dedicated resource pool for SL PRS does not comprise sidelink feedback resources.

Preferably in certain embodiments, PSSCH may mean sidelink data transmission.

Preferably in certain embodiments, PSFCH may mean sidelink feedback transmission.

Preferably in certain embodiments, PSCCH may mean sidelink control transmission.

Preferably in certain embodiments, for transmitting PSSCH in a slot or subslot, the TX UE needs to transmit SCI in the slot or the subslot for scheduling the PSSCH.

Preferably in certain embodiments, for transmitting SL PRS in a slot or subslot, the TX UE needs to transmit SCI in the slot or the subslot for scheduling the SL PRS.

Preferably in certain embodiments, the slot may mean a sidelink slot. Preferably in certain embodiments, the slot may be represented/replaced as a Transmission Time Interval (TTI).

Preferably in certain embodiments, the sidelink slot may mean slot for sidelink. Preferably in certain embodiments, a TTI may be a subframe (for sidelink) or slot (for sidelink) or sub-slot (for sidelink). Preferably in certain embodiments, a TTI comprises multiple symbols, e.g., 12 or 14 symbols. Preferably in certain embodiments, a TTI may be a slot (fully/partially) comprising sidelink symbols. Preferably in certain embodiments, a TTI may mean a transmission time interval for a sidelink (data) transmission. Preferably in certain embodiments, a sidelink slot or a slot for sidelink may contain all Orthogonal Frequency Division Multiplexing (OFDM) symbols available for sidelink transmission. Preferably in certain embodiments, a sidelink slot or a slot for sidelink may contain a consecutive number of symbols available for sidelink transmission. Preferably in certain embodiments, a sidelink slot or a slot for sidelink means that a slot is included/comprised in a sidelink resource pool.

Preferably in certain embodiments, the symbol may mean a symbol indicated/configured for sidelink.

Preferably in certain embodiments, the slot may mean/comprise a sidelink slot associated with the (sidelink) resource pool. Preferably in certain embodiments, the slot may not mean/comprise a sidelink slot associated with other (sidelink) resource pool.

Preferably in certain embodiments, the contiguous/consecutive slots may mean contiguous sidelink slots in/for the (sidelink) resource pool.

Preferably in certain embodiments, the contiguous/consecutive slots may or may not be contiguous/consecutive in physical slots. It means that the contiguous/consecutive slots in the sidelink resource pool may be not contiguous/consecutive from the aspect of physical slots. Preferably in certain embodiments, the contiguous/consecutive slots may or may not be contiguous/consecutive in sidelink slots in/for a sidelink Bandwidth Part (BWP) or a sidelink carrier/cell. It means that the contiguous/consecutive slots in the (sidelink) resource pool may be not contiguous/consecutive from the aspect of sidelink slots in a sidelink BWP or a sidelink carrier/cell. Preferably in certain embodiments, there may be one or more (sidelink) resource pools in a sidelink BWP or a sidelink carrier/cell.

Preferably in certain embodiments, a sub-channel is a unit for sidelink resource allocation/scheduling (for PSSCH). Preferably in certain embodiments, a sub-channel may comprise multiple contiguous PRBs in frequency domain. Preferably in certain embodiments, the number of PRBs for each sub-channel may be (pre-) configured for a sidelink resource pool. Preferably in certain embodiments, a sidelink resource pool (pre-) configuration may indicate/configure the number of PRBs for each sub-channel. Preferably in certain embodiments, the number of PRBs for each sub-channel may be any of 10, 12, 15, 20, 25, 50, 75, 100. Preferably in certain embodiments, a sub-channel may be represented as a unit for sidelink resource allocation/scheduling. Preferably in certain embodiments, a sub-channel may mean a set of consecutive PRBs in frequency domain. Preferably in certain embodiments, a sub-channel may mean a set of consecutive resource elements in frequency domain.

Preferably in certain embodiments, the first UE may have/maintain/establish multiple sidelink links/connections on PC5 interface. For different sidelink links/connections, the first UE may perform sidelink transmission/reception to/from different paired UE(s).

Preferably in certain embodiments, the first UE may have/maintain/establish a first sidelink link/connection and a second sidelink link/connection. The paired UE of the first sidelink link/connection may be different from the paired UE of the second sidelink link/connection. Preferably in certain embodiments, the sidelink logical channel(s) associated with (the paired UE of) the first sidelink link/connection are separate/independent from the sidelink logical channel(s) associated with (the paired UE of) the second sidelink link/connection.

Preferably in certain embodiments, the UE may be/mean/comprise/replace a device.

Preferably in certain embodiments, the sidelink transmission/reception may be UE-to-UE transmission/reception. Preferably in certain embodiments, the sidelink transmission/reception may be device-to-device transmission/reception. Preferably in certain embodiments, the sidelink transmission/reception may be Vehicle-to-Everything (V2X) transmission/reception. Preferably in certain embodiments, the sidelink transmission/reception may be Pedestrian-to-Everything (P2X) transmission/reception. Preferably in certain embodiments, the sidelink transmission/reception may be on PC5 interface.

Preferably in certain embodiments, the PC5 interface may be a wireless interface for communication between device and device. Preferably in certain embodiments, the PC5 interface may be a wireless interface for communication between devices. Preferably in certain embodiments, the PC5 interface may be a wireless interface for communication between UEs. Preferably in certain embodiments, the PC5 interface may be a wireless interface for V2X or P2X communication. Preferably in certain embodiments, the Uu interface may be a wireless interface for communication between network node and device. Preferably in certain embodiments, the Uu interface may be a wireless interface for communication between network node and UE.

Preferably in certain embodiments, the first UE may be a first device. Preferably in certain embodiments, the first UE may be a vehicle UE. Preferably in certain embodiments, the first UE may be a V2X UE.

Preferably in certain embodiments, the second UE may be a second device. Preferably in certain embodiments, the second UE may be a vehicle UE. Preferably in certain embodiments, the second device may be a V2X UE.

Preferably in certain embodiments, the first UE and the second device are different devices. Various examples and embodiments of the present invention are described below.

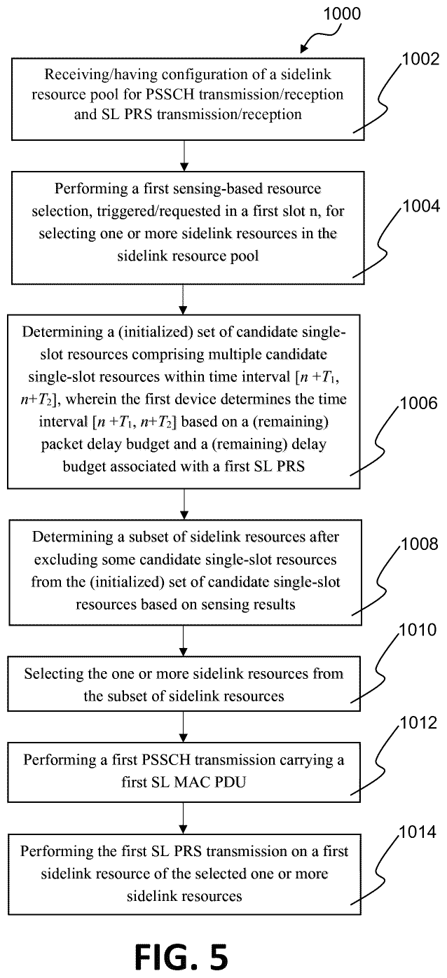

Referring to FIG. 5, with this and other concepts, systems, and methods of the present invention, a method 1000 for a first device in a wireless communication system comprises receiving/having configuration of a sidelink resource pool for PSSCH transmission/reception and SL PRS transmission/reception (step 1002), performing a first sensing-based resource selection, triggered/requested in a first slot n, for selecting one or more sidelink resources in the sidelink resource pool (step 1004), determining a (initialized) set of candidate single-slot resources comprising multiple candidate single-slot resources within time interval [n+T₁, n+T₂], wherein the first device determines the time interval [n+T₁, n+T₂] based on a (remaining) packet delay budget and a (remaining) delay budget associated with a first SL PRS (step 1006), determining a subset of sidelink resources after excluding some candidate single-slot resources from the (initialized) set of candidate single-slot resources based on sensing results (step 1008), selecting the one or more sidelink resources from the subset of sidelink resources (step 1010), performing a first PSSCH transmission carrying a first SL MAC

PDU (step 1012), and performing the first SL PRS transmission on a first sidelink resource of the selected one or more sidelink resources (step 1014).

In various embodiments, the first SL PRS transmission is multiplexed with the first PSSCH transmission on the first sidelink resource.

In various embodiments, the SL MAC PDU comprises SL data in/from sidelink logical channel(s), and/or the packet delay budget is determined/associated with the SL data or the sidelink logical channel(s).

Referring back to FIGS. 3 and 4, in one or more embodiments from the perspective of a first device in a wireless communication system, the device 300 includes a program code 312 stored in memory 310 of the transmitter. The CPU 308 could execute program code 312 to: (i) receive/have configuration of a sidelink resource pool for PSSCH transmission/reception and SL PRS transmission/reception; (ii) perform a first sensing-based resource selection, triggered/requested in a first slot n, for selecting one or more sidelink resources in the sidelink resource pool; (iii) determine a (initialized) set of candidate single-slot resources comprising multiple candidate single-slot resources within time interval [n+T₁, n+T₂], wherein the first device determines the time interval [n+T₁, n+T₂] based on a (remaining) packet delay budget and a (remaining) delay budget associated with a first SL PRS; (iv) determine a subset of sidelink resources after excluding some candidate single-slot resources from the (initialized) set of candidate single-slot resources based on sensing results; (v) select the one or more sidelink resources from the subset of sidelink resources; (vi) perform a first PSSCH transmission carrying a first SL MAC PDU; and (vii) perform the first SL PRS transmission on a first sidelink resource of the selected one or more sidelink resources. Moreover, the CPU 308 can execute the program code 312 to perform all of the described actions, steps, and methods described above, below, or otherwise herein.

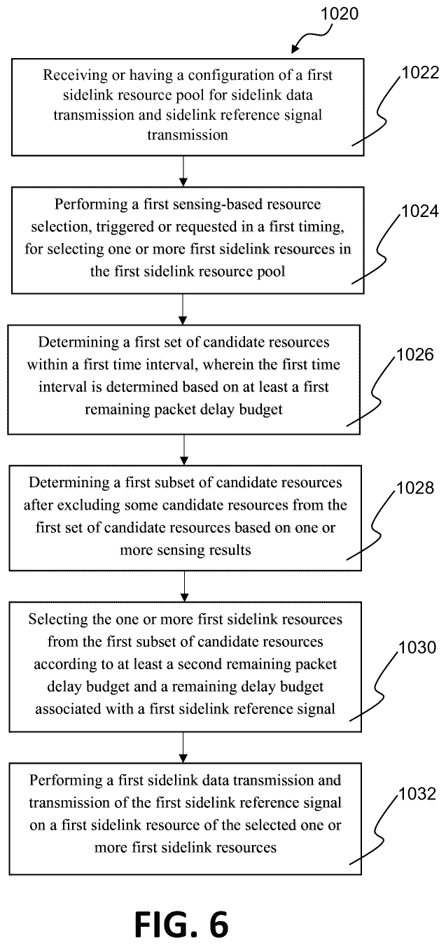

Referring to FIG. 6, with this and other concepts, systems, and methods of the present invention, a method 1020 for a first device in a wireless communication system comprises receiving or having a configuration of a first sidelink resource pool for sidelink data transmission and sidelink reference signal transmission (step 1022), performing a first sensing-based resource selection, triggered or requested in a first timing, for selecting one or more first sidelink resources in the first sidelink resource pool (step 1024), determining a first set of candidate resources within a first time interval, wherein the first time interval is determined based on at least a first remaining packet delay budget (step 1026), determining a first subset of candidate resources after excluding some candidate resources from the first set of candidate resources based on one or more sensing results (step 1028), selecting the one or more first sidelink resources from the first subset of candidate resources according to at least a second remaining packet delay budget and a remaining delay budget associated with a first sidelink reference signal (step 1030), and performing a first sidelink data transmission and transmission of the first sidelink reference signal on a first sidelink resource of the selected one or more first sidelink resources (step 1032).

In various embodiments, the first device determines the first time interval not based on the remaining delay budget associated with the first sidelink reference signal. For determining the first time interval, the first device does not consider the remaining delay budget associated with the first sidelink reference signal.

In various embodiments, selecting the one or more first sidelink resources according to at least the second remaining packet delay budget and the remaining delay budget associated with the first sidelink reference signal comprises or means selecting the one or more first sidelink resources based on a shorter one of the second remaining packet delay budget and the remaining delay budget associated with the first sidelink reference signal, and/or selecting the one or more first sidelink resources according to at least the second remaining packet delay budget and the remaining delay budget associated with the first sidelink reference signal comprises or means selecting the one or more first sidelink resources such that the one or more first sidelink resources are within the second remaining packet delay budget and within the remaining delay budget associated with the first sidelink reference signal, and/or selecting the one or more first sidelink resources according to at least the second remaining packet delay budget and the remaining delay budget associated with the first sidelink reference signal comprises or means selecting the one or more first sidelink resources such that the one or more first sidelink resources are within the shorter one of the second remaining packet delay budget and the remaining delay budget associated with the first sidelink reference signal.

In various embodiments, the first sidelink data transmission includes a first sidelink data packet, which comprises sidelink data in or from a sidelink logical channel, and/or the first remaining packet delay budget is determined or associated with the sidelink data or the sidelink logical channel, and/or the second remaining packet delay budget is determined or associated with the sidelink data or the sidelink logical channel, and/or the second remaining packet delay budget is the same or identical to the first remaining packet delay budget, and/or the second remaining packet delay budget is smaller than or equal to the first remaining packet delay budget.

In various embodiments, the first sidelink reference signal does not belong to a sidelink logical channel, and/or the first sidelink reference signal is multiplexed with the first sidelink data transmission on the first sidelink resource.

In various embodiments, the determination of the first time interval based on at least the first remaining packet delay budget comprises or means an upper bound timing or an ending timing of the first time interval is determined based on at least the first remaining packet delay budget.

In various embodiments, the method further comprises receiving or having a configuration of a second sidelink resource pool dedicated for the sidelink reference signal transmission; performing a second sensing-based resource selection, triggered or requested in a second timing, for selecting one or more second sidelink resources in the second sidelink resource pool; determining a second set of candidate resources within a second time interval, wherein the second time interval is determined based on at least a remaining delay budget associated with a second sidelink reference signal; determining a second subset of candidate resources after excluding some candidate resources from the second set of candidate resources based on one or more sensing results; selecting the one or more second sidelink resources from the second subset of candidate resources according to at least the remaining delay budget associated with the second sidelink reference signal; and performing transmission of the second sidelink reference signal on a second sidelink resource of the selected one or more second sidelink resources.

In various embodiments, the second sidelink resource pool comprises sidelink control resources, and/or the second sidelink resource pool does not comprise sidelink data resources.

In various embodiments, the first device determines the second time interval not based on any remaining packet delay budget.

In various embodiments, the sidelink data transmission means PSSCH transmission, and/or the sidelink reference signal means SL-PRS, and/or the sidelink reference signal means SL CSI-RS for beam management, and/or the sidelink reference signal is utilized for any of positioning, ranging, beam management, high-resolution localization, sensing, or imaging.

Referring back to FIGS. 3 and 4, in one or more embodiments from the perspective of a first device in a wireless communication system, the device 300 includes a program code 312 stored in memory 310 of the transmitter. The CPU 308 could execute program code 312 to: (i) receive or have a configuration of a first sidelink resource pool for sidelink data transmission and sidelink reference signal transmission; (ii) perform a first sensing-based resource selection, triggered or requested in a first timing, for selecting one or more first sidelink resources in the first sidelink resource pool; (iii) determine a first set of candidate resources within a first time interval, wherein the first time interval is determined based on at least a first remaining packet delay budget; (iv) determine a first subset of candidate resources after excluding some candidate resources from the first set of candidate resources based on one or more sensing results; (v) select the one or more first sidelink resources from the first subset of candidate resources according to at least a second remaining packet delay budget and a remaining delay budget associated with a first sidelink reference signal; and (vi) perform a first sidelink data transmission and transmission of the first sidelink reference signal on a first sidelink resource of the selected one or more first sidelink resources. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method of a first device, comprising:
receiving or having a configuration of a first sidelink resource pool for sidelink data transmission and sidelink reference signal transmission;
performing a first sensing-based resource selection, triggered or requested in a first timing, for selecting one or more first sidelink resources in the first sidelink resource pool;
determining a first set of candidate resources within a first time interval, wherein the first time interval is determined based on at least a first remaining packet delay budget;
determining a first subset of candidate resources after excluding some candidate resources from the first set of candidate resources based on one or more sensing results;
selecting the one or more first sidelink resources from the first subset of candidate resources according to at least a second remaining packet delay budget and a remaining delay budget associated with a first sidelink reference signal; and
performing a first sidelink data transmission and transmission of the first sidelink reference signal on a first sidelink resource of the selected one or more first sidelink resources.

2. The method of claim 1, wherein the first device determines the first time interval not based on the remaining delay budget associated with the first sidelink reference signal.

3. The method of claim 1, wherein:
selecting the one or more first sidelink resources according to at least the second remaining packet delay budget and the remaining delay budget associated with the first sidelink reference signal comprises selecting the one or more first sidelink resources based on a shorter one of the second remaining packet delay budget and the remaining delay budget associated with the first sidelink reference signal, and/or
selecting the one or more first sidelink resources according to at least the second remaining packet delay budget and the remaining delay budget associated with the first sidelink reference signal comprises selecting the one or more first sidelink resources such that the one or more first sidelink resources are within the second remaining packet delay budget and within the remaining delay budget associated with the first sidelink reference signal, and/or
selecting the one or more first sidelink resources according to at least the second remaining packet delay budget and the remaining delay budget associated with the first sidelink reference signal comprises selecting the one or more first sidelink resources such that the one or more first sidelink resources are within the shorter one of the second remaining packet delay budget and the remaining delay budget associated with the first sidelink reference signal.

4. The method of claim 1, wherein:
the first sidelink data transmission includes a first sidelink data packet, which comprises sidelink data in or from a sidelink logical channel, and/or
the first remaining packet delay budget is determined or associated with the sidelink data or the sidelink logical channel, and/or
the second remaining packet delay budget is determined or associated with the sidelink data or the sidelink logical channel, and/or
the second remaining packet delay budget is the same or identical to the first remaining packet delay budget, and/or
the second remaining packet delay budget is smaller than or equal to the first remaining packet delay budget.

5. The method of claim 1, wherein:
the first sidelink reference signal does not belong to a sidelink logical channel, and/or
the first sidelink reference signal is multiplexed with the first sidelink data transmission on the first sidelink resource.

6. The method of claim 1, wherein:
the determination of the first time interval based on at least the first remaining packet delay budget comprises an upper bound timing or an ending timing of the first time interval is determined based on at least the first remaining packet delay budget.

7. The method of claim 1, further comprising:
receiving or having a configuration of a second sidelink resource pool dedicated for the sidelink reference signal transmission;
performing a second sensing-based resource selection, triggered or requested in a second timing, for selecting one or more second sidelink resources in the second sidelink resource pool;
determining a second set of candidate resources within a second time interval, wherein the second time interval is determined based on at least a remaining delay budget associated with a second sidelink reference signal;
determining a second subset of candidate resources after excluding some candidate resources from the second set of candidate resources based on one or more sensing results;
selecting the one or more second sidelink resources from the second subset of candidate resources according to at least the remaining delay budget associated with the second sidelink reference signal; and
performing transmission of the second sidelink reference signal on a second sidelink resource of the selected one or more second sidelink resources.

8. The method of claim 7, wherein:
the second sidelink resource pool comprises sidelink control resources, and/or
the second sidelink resource pool does not comprise sidelink data resources.

9. The method of claim 7, wherein the first device determines the second time interval not based on any remaining packet delay budget.

10. The method of claim 1, wherein:
the sidelink data transmission is Physical Sidelink Shared Channel (PSSCH) transmission, and/or
the sidelink reference signal is Sidelink Positioning Reference Signal (SL-PRS), and/or
the sidelink reference signal is SL Channel State Information Reference Signal (CSI-RS) for beam management, and/or
the sidelink reference signal is utilized for any of positioning, ranging, beam management, high-resolution localization, sensing, or imaging.

11. A first device, comprising:
a memory; and
a processor operatively coupled to the memory, wherein the processor is configured to execute a program code to:
receive or have a configuration of a first sidelink resource pool for sidelink data transmission and sidelink reference signal transmission;
perform a first sensing-based resource selection, triggered or requested in a first timing, for selecting one or more first sidelink resources in the first sidelink resource pool;
determine a first set of candidate resources within a first time interval, wherein the first time interval is determined based on at least a first remaining packet delay budget;
determine a first subset of candidate resources after excluding some candidate resources from the first set of candidate resources based on one or more sensing results;
select the one or more first sidelink resources from the first subset of candidate resources according to at least a second remaining packet delay budget and a remaining delay budget associated with a first sidelink reference signal; and
perform a first sidelink data transmission and transmission of the first sidelink reference signal on a first sidelink resource of the selected one or more first sidelink resources.

12. The first device of claim 11, wherein the first device determines the time interval not based on the remaining delay budget associated with the first sidelink reference signal.

13. The first device of claim 11, wherein:
selecting the one or more first sidelink resources according to at least the second remaining packet delay budget and the remaining delay budget associated with the first sidelink reference signal comprises selecting the one or more first sidelink resources based on a shorter one of the second remaining packet delay budget and the remaining delay budget associated with the first sidelink reference signal, and/or
selecting the one or more first sidelink resources according to at least the second remaining packet delay budget and the remaining delay budget associated with the first sidelink reference signal comprises selecting the one or more first sidelink resources such that the one or more first sidelink resources are within the second remaining packet delay budget and within the remaining delay budget associated with the first sidelink reference signal, and/or
selecting the one or more first sidelink resources according to at least the second remaining packet delay budget and the remaining delay budget associated with the first sidelink reference signal comprises selecting the one or more first sidelink resources such that the one or more first sidelink resources are within the shorter one of the second remaining packet delay budget and the remaining delay budget associated with the first sidelink reference signal.

14. The first device of claim 11, wherein:
the first sidelink data transmission includes a first sidelink data packet, which comprises sidelink data in or from a sidelink logical channel, and/or
the first remaining packet delay budget is determined or associated with the sidelink data or the sidelink logical channel, and/or
the second remaining packet delay budget is determined or associated with the sidelink data or the sidelink logical channel, and/or
the second remaining packet delay budget is the same or identical to the first remaining packet delay budget, and/or
the second remaining packet delay budget is smaller than or equal to the first remaining packet delay budget.

15. The first device of claim 11, wherein:
the first sidelink reference signal does not belong to a sidelink logical channel, and/or
the first sidelink reference signal is multiplexed with the first sidelink data transmission on the first sidelink resource.

16. The first device of claim 11, wherein:
the determination of the first time interval based on at least the first remaining packet delay budget comprises an upper bound timing or an ending timing of the first time interval is determined based on at least the first remaining packet delay budget.

17. The first device of claim 11, wherein the processor is further configured to execute the program code to:
receive or have a configuration of a second sidelink resource pool dedicated for the sidelink reference signal transmission;
perform a second sensing-based resource selection, triggered or requested in a second timing, for selecting one or more second sidelink resources in the second sidelink resource pool;
determine a second set of candidate resources within a second time interval, wherein the second time interval is determined based on at least a remaining delay budget associated with a second sidelink reference signal;
determine a second subset of candidate resources after excluding some candidate resources from the second set of candidate resources based on one or more sensing results;
select the one or more second sidelink resources from the second subset of candidate resources according to at least the remaining delay budget associated with the second sidelink reference signal; and
perform transmission of the second sidelink reference signal on a second sidelink resource of the selected one or more second sidelink resources.

18. The first device of claim 17, wherein:
the second sidelink resource pool comprises sidelink control resources, and/or
the second sidelink resource pool does not comprise sidelink data resources.

19. The first device of claim 17, wherein the first device determines the second time interval not based on any remaining packet delay budget.

20. The first device of claim 11, wherein:
the sidelink data transmission is Physical Sidelink Shared Channel (PSSCH) transmission, and/or
the sidelink reference signal is Sidelink Positioning Reference Signal (SL-PRS), and/or
the sidelink reference signal is SL Channel State Information Reference Signal (CSI-RS) for beam management, and/or
the sidelink reference signal is utilized for any of positioning, ranging, beam management, high-resolution localization, sensing, or imaging.
